(19) United States
(12) Patent Application Publication
(10) Pub. No.: US 2008/0128383 A1
(43) Pub. Date: Jun. 5, 2008

(54) ETCHING APPARATUS AND ETCHING METHOD

(75) Inventor: Hiroki Tamano, Tochigi (JP)

Correspondence Address: BELL, BOYD & LLOYD, LLP, P.O. Box 1135, CHICAGO, IL, 60690, US

(73) Assignee: SONY CHEMICAL & INFORMATION DEVICE CORPORATION, Tokyo (JP)

(21) Appl. No.: 11/970,400

(22) Filed: Jan. 7, 2008

Related U.S. Application Data
(63) Continuation of application No. PCT/JP2005/012786, filed on Jul. 11, 2005.

(51) Int. Cl. H01B 13/00

(52) U.S. Cl. 216/13; 156/345.21

(57) ABSTRACT

An etching apparatus for forming conductor patterns by etching a wiring board is provided. The etching apparatus includes a drum, a chamber and a nozzle head. The drum is configured to run a flexible wiring board under rotation while turning it around a drum face. The chamber is a chamber for storing an etching liquid under a constant pressure. The nozzle head is arranged at a position in the vicinity of the drum face in an upper portion of the chamber. The etching liquid pressurized in the chamber is linearly ejected onto the drum face through the nozzle holes.

### CROSS REFERENCE TO RELATED APPLICATIONS

The present application is a Continuation of International Application No. PCT/JP2005/012786 filed on Jul. 11, 2005. The entire disclosure of the prior application is hereby incorporated by reference herein in its entireties.

### BACKGROUND

The present application generally relates to an etching apparatus to be used for forming conductor patterns by etching a wiring board having flexibility. More particularly, the present application relates to an etching method of conducting wet etching on the wiring board when conductor patterns are formed on the wiring board.

In a flexible wiring board to be used in a mounting system such as an COF or a TAB, the pitch of conductors 3a has come to be smaller as shown in FIG. 1A, and finer conductors with a line/space=15/15 μm or less have been required. Further, as the signals have come to possess higher frequencies, the resistance of the conductor becomes an important factor, and it is required that the pitch of the conductor patterns 3a is not only narrower, but also the cross-sectional shape of the conductor patterns 3a is accurately rectangular.

In general, when a subtractive method is used in forming a flexible wiring board having predetermined conductor patterns by using a flexible wiring board 3, an etching resist 3c is coated on a copper foil which is laminated on an insulating film 3b of such as a polyimide, after that, predetermined patterns are exposed by using a mask and further developed, and the exposed copper foil is removed by etching, thereby forming predetermined conductor patterns 3a. And, as to the conductor patterns 3a formed on the flexible wiring board 3, in order to realize the narrower pitch and the rectangular sectional shape precision-improving measures are required over the materials and the entire steps including a pretreatment (washing), etching resist, exposure, etching and so on, and particularly a precision-improving measure is important in the etching step.

Meanwhile, it is proposed in the etching step to be employed in a process for producing the flexible printed wiring board, as shown in FIG. 2, that spray nozzles 100 are arranged in an upper position and/or a lower position apart, by around 50 to 200 mm, from a flexible wiring board 3 to be horizontally transferred, and a wide area is etched by spraying an etching liquid 5 through the spray nozzles 100 in a fan-shaped or a conical shape (See JPA H07-150370). FIG. 2 shows the construction that the spray nozzles 100 are arranged only on the upper side of the flexible wiring board 3.

Further, in order to prevent the phenomenon that the etching liquid 5 accumulates on the flexible wiring board 3 in the step of spraying the etching liquid 5, an etching apparatus is proposed, in which spray nozzles 100 are arranged only on the lower side of the flexible wiring board 3, and the etching liquid 5 is sprayed (See JPA 2003-55779).

Furthermore, in order to make finer the conductor patterns 3a to be formed on a flexible wiring board 3 and make their cross-sectional shape rectangular at a high precision, an electrolytically etching method is proposed, in which edges of a metal strip to constitute formed conductor patterns 3a are masked for preventing the edges from being etched (JPA H08-209400). In this electrolytically etching method, a main roll and an electrode of a semicircular section are dipped in an electrolysis cell filled with an electrolysis solution, and the masking tape-adhered metal strip is passed therebetween and immersed in the electrolysis solution.

However, the above-mentioned etching methods and apparatuses conventionally used or proposed have the following problems.

In the method of etching by using the above-mentioned etching apparatus as shown in FIG. 2, when the upper face side of the flexible wiring board 3 is etched, the flexible wiring board 3 is bent down by the ejection pressure of the etching liquid 5 ejected through the spray nozzles 100 and the weight of the etching liquid 5 accumulated on the upper face of the flexible wiring board 3. Consequently, the etching liquid 5 does not impinge upon the bent portion at ordinarily ejected angles, and the etching liquid 5 accumulates in the bent portion to prevent a fresh etching liquid 5 from impinging thereupon. This makes it difficult to form the finer conductor patterns 3a by etching at a high precision.

Even if the etching liquid 5 is ejected only on the lower face side of the flexible wiring board 3, the etching liquid 5 does not impinge, at ordinarily ejected angles, upon portions bent by the ejection pressure of the ejected etching liquid 5, so that it similarly becomes difficult to form the fine conductor patterns 3a by etching at a high precision.

The problems of the accumulation of the etching liquid 5 on the flexible wiring board 3 and the ejected angles of the etching liquid 5 to the flexible wiring board 3 cause earlier etched portions of the conductor patterns 3a as shown in FIG. 1C and more slowly etched portions of the conductor patterns 3a as shown in FIG. 1B in the flexible wiring board 3. Eventually, this leads to variations in the width and the sectional shape of the conductor patterns 3a.

On the other hand, the etching liquid 5 is generally likely to collect in a widthwise central portion of the flexible wiring board 3, and the etching speed tends to be slower in the widthwise central portion than in edge portions of both sides. In the conventional etching apparatuses, the spray nozzles 100 are oscillated, or the arrangement of the spray nozzles 100 or the ejection pressure of the etching liquid 5 was adjusted.

However, it is difficult to make the etching speed uniform over the entire region on the face of the flexible wiring board 3. Further, even if the bending of the flexible wiring board 3 is prevented, the ejected etching liquid 5 is spread in a fan-like shape or a conical shape due to the characteristic of the spray nozzle 100. Consequently, the ejection pressure for the flexible wiring board 3 becomes non-uniform, so that variations in the width and the cross-sectional shape of the etched conductor patterns 3a have not been fundamentally solved yet.

Meanwhile, in the method where the flexible wiring board 3 is etched by ejecting the etching liquid 5 thereto so as to form the conductor patterns 3a on the flexible wiring board 3, there occur the phenomena that the etching speed partially varies owing to variations in the ejection pressure of the etching liquid 5 onto the flexible wiring board 3, the differences in the ejection angles, and the bending of the flexible wiring board 3 and so on as mentioned above. To cope with such phenomena, the etching speed is determined with reference to the portion of the conductor pattern 3a in which the etching is completed most slowly. In consequence, the conductor patterns 3a etched earlier are overetched as shown in FIG. 1B, and the patterns 3a of the conductor become thinner as shown in FIG. 1C.

Further, when the above-mentioned electrolytically etching method is employed to form the conductor patterns 3a, the pitches of the conductor patterns 3a can be narrowed by immersing the flexible wiring board 3 turned around the main roll in the etching liquid 5 filled up in the vessel, but a rapidly etching effect based on the spaying of the etching liquid 5 cannot be obtained. Furthermore, since the etching method employed here is carried out by immersing the flexible wiring board 3 into the etching liquid 5 charged in the vessel, there is no directionality in etching the conductor patterns 3a, and thus the cross-sectional shape of the conductor patterns 3a cannot be made rectangular.

### SUMMARY

The present application provides a novel etching apparatus and method which can solve the problems in the conventional etching apparatuses and etching methods in an embodiment.

The present application provides an etching apparatus and an etching method in which the etching speed for the wiring board can be made uniform, the pitch of the formed conductor patterns can be narrowed, and the cross-sectional shape can be formed at a high precision, so that the conductor patterns can be formed at a high precision to cope with the transmission of high-frequency signals in an embodiment.

The present application in an embodiment is directed to an etching apparatus in which a wiring board is turned around an a drum face of an outer periphery of a drum, the wiring board turned around the drum face is run by rotating the drum, and etching is carried out by ejecting an etching liquid onto the wiring board turned around the drum face through a nozzle head, wherein the nozzle head is disposed at a position in the vicinity of the drum face and the nozzle head is provided with plural nozzles so as to linearly eject the etching liquid onto the drum face.

The present application in an embodiment is also directed to a method in which etching is carried out by ejecting the etching liquid onto a running wiring board, wherein while the wiring board is turned around a drum face on an outer periphery of a drum, the wiring board is run under rotation of the drum, and the etching liquid is linearly ejected onto the wiring board on the drum face from positions in the vicinity of the drum face.

In the following explanation, “etching speed” means a reacting speed at which a conductor not covered with an etching resist at the surface of the wiring board is removed from the wiring board by etching. When a case where a cross-sectional shape of the etched conductor pattern is rectangular is taken as a standard, such a case where the width of the conductor patterns is large and the conductor patterns are thick is called as “slow etching speed”, whereas such a case where the width of the conductor patterns is small and the conductor patterns are thin is called as “high etching speed”.

According to an embodiment, since the wiring board is run, while the wiring board is turned around the drum, the wiring board receiving the ejection pressure of the etching liquid ejected through the nozzle head can be borne by the drum face, and thus, the bending of the wiring board can be prevented. The linear advancing and the constant ejection pressure of the etching liquid can be ensured by linearly ejecting the etching liquid onto the wiring board on the drum face from the positions in the vicinity of the drum face. In addition, since the bending of the wiring board is prevented and the linear advancing and the constant ejection pressure of the etching liquid can be ensured, the narrower pitch of the conductor patterns can be realized by making the etching speed of the wiring board uniform, and the cross-sectional shape of the conductor patterns can be formed at a high precision.

Additional features and advantages are described herein, and will be apparent from, the following Detailed Description and the figures.

### BRIEF DESCRIPTION OF THE FIGURES

FIG. 1A is a cross-sectional view of a wiring board, showing a state in which conductor patterns having a rectangular conductor section are formed under a normal etching speed, FIG. 1B is a cross-sectional view of a wiring board, showing a state in which the cross-sectional shape of conductor patterns is thicker under a slow etching speed, and FIG. 1C is a cross-sectional view of a wiring board, showing a state in which the sectional shape of conductor patterns was thinner under a high etching speed.

FIG. 2 is a side view showing an outlined construction of the conventional etching apparatus.

FIG. 3 is a front view showing an outlined construction of an etching chamber equipped with an etching apparatus according to an embodiment.

FIG. 4 is a front cross-sectional view showing a drum and a nozzle head of the etching apparatus in an enlarged scale.

FIG. 5 is a plane view showing a nozzle head in which nozzle holes are formed by plural slit-like through-holes.

FIG. 6 is a plane view showing a nozzle head in which nozzle holes are formed by plural circular through-holes.

FIG. 7 is a front view showing another embodiment of the etching apparatus according to an embodiment.

FIG. 8 is a front view showing a further embodiment of the etching apparatus according to an embodiment.

### DETAILED DESCRIPTION

The present application is described below in greater detail with reference to the drawings according to an embodiment.

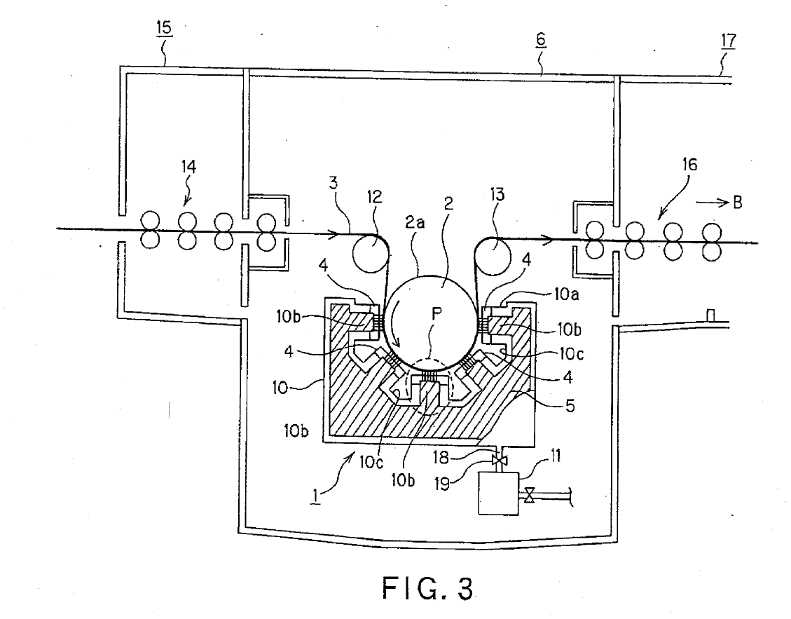

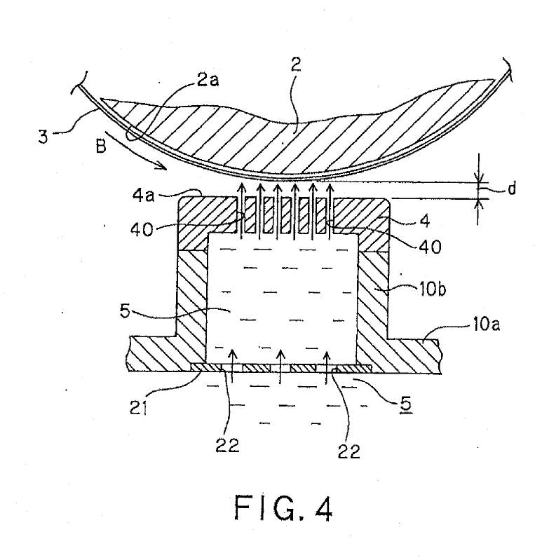

As shown in FIGS. 3 and 4, an etching apparatus 1 according to an embodiment is an apparatus in which a nozzle head 4 is disposed in the vicinity of a flexible wiring board 3 turned around an outer peripheral face of a drum 2, and an etching liquid 5 is linearly ejected onto the flexible wiring board 3 through the nozzle head 4.

The etching apparatus 1 is used in an etching step among respective steps in a subtractive process in which conductor patterns are formed on the flexible wiring board 3, and the etching apparatus is disposed in an etching chamber 6 in an etching system constituted by connecting treatment chambers for performing the respective steps.

As shown in FIGS. 3 and 4, the etching apparatus 1 has a drum 2, a chamber 10, nozzle heads 4, and a pump 11 and so on.

The drum 2 is a cylindrical body of rotation formed with a drum face 2a around which the flexible wiring board 3 is turned onto an outer peripheral face of the drum. The flexible wiring board 3 is turned around the drum face 2a of the drum 2, while being run from a first roller 12 on an upstream side toward a second roller 13 on a downstream side.

Now, the etching chamber 6 in which the etching apparatus 1 according to an embodiment is arranged will be explained. The etching chamber 6 is connected between a first washing chamber 15 provided with a row 14 of first tension rollers on the upstream and a second washing chamber 17 provided with a row 16 provided with second tension rollers on the downstream sides. The speed of the first and second tension roller rows 14 and 16 is so controlled that the flexible wiring board 3 may run at a constant speed under a constant tension.

The driving of the drum 2 is controlled so as to become the peripheral speed identical with the speed of the flexible wiring board 3 running between the first and second tension roller rows 14 and 16. The drum 2 may be supported so as to rotate, without being positively driven to rotate, according to the running of the flexible wiring board 3. In this case, the drum 2 is desirably so supported in a rotation-free state as to receive a small supporting resistance at a time of rotation.

The chamber 10 is a space to store the etching liquid 5, and is disposed under the drum 2. A pump 11 is connected to a side wall portion of the chamber 10 via a duct 18, a valve 19 and so one. The pump 11 is configured to adjust the chamber 10 to a constant pressure by feeding the etching liquid 5 thereinto under pressure. Further, a concave upper wall portion 10a is formed at an upper portion of the chamber 10, and this upper wall portion 10a is opposed to the drum face 2. In this case, almost a half portion of the cylinder on an upper side of the drum is protruded from the chamber 10, and almost a half portion of the cylinder on a lower side is sunk in the chamber 10.

As shown in FIG. 3, the upper wall portion 10a is formed in a circular arc shape almost along the outer peripheral direction of the drum 2, and concave and convex portions are formed at the surface thereof. The convex portions among the concave and convex portions are designed as nozzle-fitting portions 10b. The nozzle-fitting portions 10b are plural and are arranged at a given interval in an outer peripheral direction of the drum 2, in such a manner that the nozzle-fitting portion 10b extends in normal directions to the drum face 2a, that is, in directions toward the center of the drum 2. The nozzle-fitting portion 10b is formed in a cylindrical shape having a rectangular section, and is opened on an upper side. Meanwhile, the concave portions 10c formed between the adjacent nozzle-fitting portions 10b, 10b function as a drain passage for the etching liquid 5.

A nozzle head 4 is attachably fitted to an opening portion of the nozzle-fitting portion 10b by screws or the like. The nozzle heads 4 linearly ejects the etching liquid 5 pressurized within the chamber 10 onto the drum face 2a at a given interval over given areas in the peripheral direction of the drum 2, while opposed to the drum face 2a. The nozzle head 4 is formed in a rectangular lid-like shape so as to cover the opening of the nozzle-fitting portion 10b.

When the nozzle head 4 is fitted to the nozzle-fitting portion 10b, it is disposed at a position in the vicinity of the drum face 2a as shown in FIG. 4. At this time, a distance “d” between a nozzle face 4a and the drum face 2a is set at around 1 to 10 mm. If the distance “d” between the nozzle face 4a and the drum face 2a is smaller than 1 mm, the etching liquid 5 which is ejected toward the flexible wiring board 3 and impinged upon and bounced on the flexible wiring board 3 clashes with the etching liquid 5 ejected through the nozzle holes 40, so that the linearity of the etching liquid 5 ejected through the nozzle holes 40 may be adversely affected. On the other hand, if the distance “d” is larger than 10 mm, the linearity of the etching liquid 5 ejected through the nozzle holes 40 relative to the flexible wiring board 3 on the drum face 2a cannot be maintained.

Further, the nozzle head 4 is provided with plural nozzle holes 40 as shown in FIG. 4. These nozzle holes 40 are formed, penetrating in almost normal directions to the drum face 2a. Here, the penetrating directions of some of the nozzle holes 40 are identical with the normal directions to the nozzle face 4a. Although the penetrating directions are not exactly identical with the normal directions to the drum face 2a, errors therebetween are so slight that no effect may be imparted upon the linearity of the etching liquid 5 ejected toward the drum face 2a through these nozzle holes 40 (See FIG. 4).

As shown in FIG. 4, a pressure-regulating plate 21 is attached to an inflow opening portion of the nozzle-fitting portion 10b. When the etching liquid 5 inside the chamber 10 flows into the individual nozzle-fitting portions 10b, the pressure-regulating plate 21 uniformly regulates the pressure of the etching liquid 5 inside each of nozzle-fitting portions 10b. The pressure-regulating plate 21 is shaped in the form of a plate-like body to block up the inflow opening portion of the nozzle-fitting portion 10b, and regulating holes 22 opened in the planar body controls the amount of the etching liquid 5 which is flown into the nozzle-fitting portion 10b. Thereby, the etching liquid 5 can be ejected through the nozzle holes 40 under a uniform pressure irrespective of the location of the nozzle-fitting portion 10b.

Next, details of the shape of the nozzle holes 40 and so on will be explained with a method of controlling the etching speed in relation to the nozzle holes 40, etc.

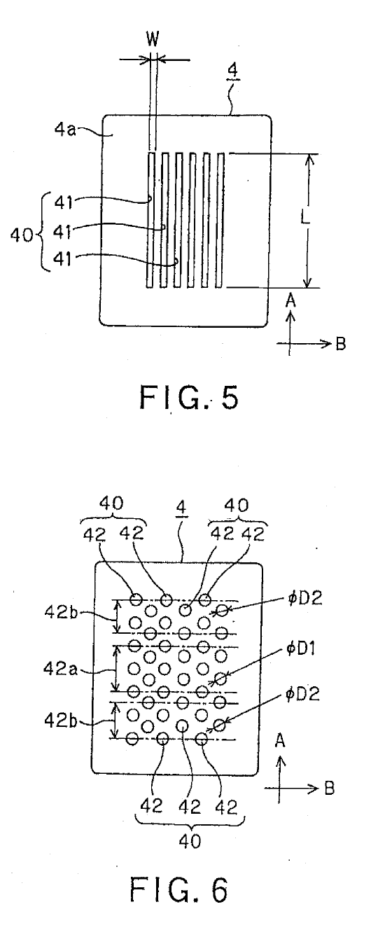

In an embodiment, either a nozzle head 4 in which nozzle holes 40 are constituted by plural slit-like through-holes 41 as shown in FIG. 5 or a nozzle head 4 in which nozzle holes 40 are constituted by plural circular through-holes 42 as shown in FIG. 6 may be used.

Here, the slit-like through-holes 41 constituting the nozzle holes 40 are formed so as to extend long and thin in generating line directions A of the drum face 2a as shown in FIG. 5. The generating line direction A of the drum face 2a corresponds to a direction in parallel to the widthwise direction A of the flexible wiring board 3 on the nozzle face 4a. It is preferable that 3 to 10 of these slit-like through-holes 41 are formed in a width W of 0.1 to 1 mm and a length L of 3 to 10 mm, while being in parallel to one another. The width W, the length and the number of the through-holes 41 become control factors to set the nozzle pressure (for example, 200 kPa) as the ejection pressure of the etching liquid 5 through the nozzle hole 40, the flow rate of the etching liquid 5 (for example, 20 m/s) and so on to optimum values, when the etching speed is set to the “standard etching speed” at which the cross-sectional shape of the formed conductor patterns is rectangular.

The nozzle head 4 which is provided with the nozzle holes 40 constituted by such slit-like through-holes 41 is useful mainly when the conductor patterns are formed by etching the flexible wiring board 3 at a uniform etching speed entirely over the width direction A thereof.

The circular through-holes 42 which constitute the nozzle holes 40 provided in the nozzle head 4 shown in FIG. 6 are formed almost in directions of the normal lines to the drum face 2a, actually circular around the directions of the normal lines to the nozzle face 4a. Such circular through-holes 42 are preferably formed in a diameter φD of 0.1 to 1 mm. The number of these through-holes 42 differs depending upon the width of the flexible wiring board 3 which is to be etched, but preferably around 10 to 50 of the through-holes are provided in one nozzle face 4a.

Similarly to the slit-like through-holes 41, the diameter φD and the provided number of the circular through-holes 42 become control factors to set optimum values for the nozzle pressure as the ejection pressure of the etching liquid 5 through the nozzle holes 40, the flow rate of the etching liquid 5 and so on, in case that the etching speed is set to “standard etching speed” at which the cross-sectional shape of the formed conductor patterns are rectangular.

The nozzle head 4 which is provided with the nozzle holes 40 constituted by such circular through-holes 42 is used when the conductor patterns are formed by etching the flexible wiring board 3 at a uniform etching speed entirely over the width direction A of the flexible wiring board 3. The nozzle head 4 is more effectively used, for example, when the conductor patterns are formed by etching a conductor which is formed, with variations in thickness, by electrolytic plating.

Meanwhile, compared with the standard thickness of the conductor patterns 3a formed by etching at the above-mentioned “standard etching speed”, in the case that the thickness of the conductor patterns 3a in the width wise central portion of the flexible wiring board 3 is greater and the thickness of the edge portions of the conductor patterns 3a thereof is smaller, it is necessary that the etching is carried out at the totally same “standard etching speed”, while the etching speed is being controlled in the widthwise central portion and the edge portions of the conductor patterns 3a.

Specifically, as compared with the standard diameter φD and the standard number of the formed circular through-holes 42 in case of the “standard etching speed”, in case of the central row of the through-holes 42a in the drum-circumferential direction B of the drum 2, the diameter φD1 of the through-holes 42 is made smaller, the number of the formed through-holes 42 is increased, and the nozzle pressure as the ejection pressure of the etching liquid 5 through the nozzle holes 40 and the total flow rate of the etching liquid 5 per unit time are increased.

Here, the circumferential direction B of the drum 2 on the nozzle face 4a is identical with the running direction B of the flexible wiring board 3.

As to the edge hole rows 42b in the circumferential direction of the drum 2, the diameter φD2 of the through-holes 42 is increased, and the number of the formed through-holes 42 is decreased, so that the nozzle pressure as the ejection pressure of the etching liquid 5 and the total flow rate of the etching liquid 5 per unit time are decreased.

As to the nozzle head 4 which is provided with the nozzle holes 40 constituted by the slit-like through-holes 41, the etching speed for the flexible wiring board 3 in the width direction A can be similarly controlled by changing the width W and the length L of the through holes 41.

On the other hand, the etching speed for the flexible wiring board 3 in the running direction B can be controlled by changing the number of the slit-like through-holes 41 and so on or changing the number of the circular through-holes 42 formed along the generating line direction A of the drum face 2a and so on. In addition, this etching speed can be also controlled by changing the number of the fixing of the nozzle heads 4 and further by changing the number of the installation of the etching apparatus 1 itself.

In the case of decreasing the etching speed for the flexible wiring board 3 in the running direction B, the control factors such as the number of the slit-like through-holes 41, the number of the circular through-holes 42, the number of the fitted nozzle heads 4 and so on are reduced, whereas in the case of gaining the etching speed for the flexible wiring board 3 in the running direction B, the number of the installation of the etching apparatus itself 1 is increased besides the above-mentioned control factors. It should be noted that the opening of the nozzle-fitting portion 10b from which the nozzle head 4 is removed is covered with a shield lid (not shown).

In the case of controlling the etching speeds for the flexible wiring board 3 in both the widthwise direction A and the running direction B in a combined manner, the control factors such as the width W and the length L of the slit-like through-holes 41, the number of the slit-like through holes 41, the number of the fitted nozzle heads 4 are adjusted in appropriate combination with the above cases.

Next, the use mode of the etching apparatus 1 according to an embodiment will be explained together with the etching method in this embodiment.

In order to form the conductor patterns 3a by etching the conductor made of a copper foil, for example, provided in the flexible wiring board 3, as shown in FIG. 3, the flexible wiring board 3 to be etched is turned around the drum face 2a of the rotating drum 2 in such a manner that the face to be etched is directed downwardly, and is run from the row 14 of the first tension rollers toward the row 16 of the second tension rollers along the upside of the upper wall portion 10a of the chamber 10.

On the other hand, the etching liquid 5 is ejected through the nozzle holes 40 of the nozzle head 4 under a uniform pressure in the state that the actuation of the pump 11 flows the etching liquid 5 into the chamber 10 and applies a constant pressure thereto. In this case, the etching liquid 5 is linearly continuously ejected along the normal directions to the drum face 2a.

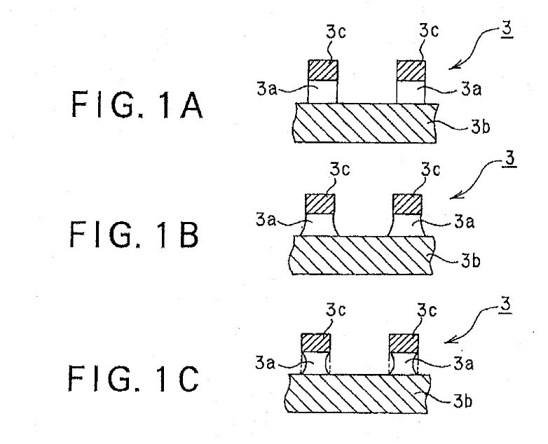

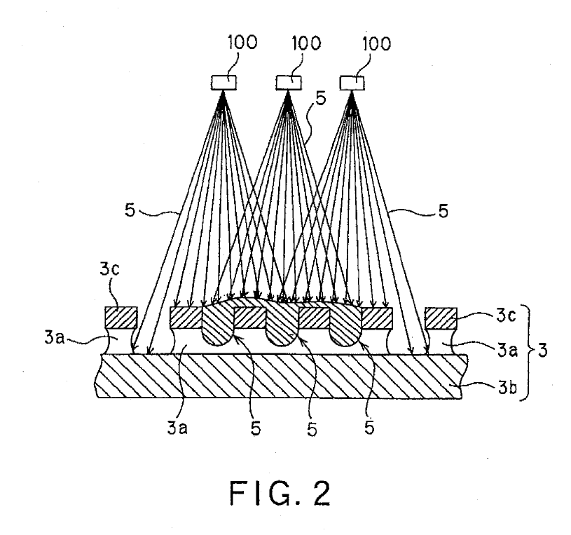

The etching liquid 5 ejected under the constant ejection pressure is ejected, vertically from adjacent positions, onto that face of the flexible wiring board 3 to be formed with the conductor patterns 3a. When the etching liquid 5 is continuously ejected in this way, those portions of the conductor on the flexible wiring board 3 which are not covered with the etching resist are dissolved by always receiving the etching liquid from the normal directions, so that the cross-sectional shape of the portions of the conductor covered with the etching resist becomes rectangular as shown in the above-mentioned FIG. 1A, thereby resulting in the etched conductor patterns 3a. Since the etching speed becomes uniform at any position on the flexible wiring board 3 by controlling the etching speeds in the width direction A and the running direction B of the flexible wiring board as mentioned above, the cross-sectional shapes of the conductor patterns 3a formed on the flexible wiring board 3 are all rectangular after the board passes one or plural chambers 10.

The etched conductor patterns 3a are formed in the uniformly rectangular section shape irrespective of the large or small pitch of the conductor patterns 3a under the condition that the etching liquid 5 is linearly ejected from the positions in the vicinity of the flexible wiring board 3 at the constant ejection pressure.

On the other hand, since the flexible wiring board 3 is supported by the drum face 2a of the drum 2 during this etching treatment, the board is not bent even upon receipt of the ejected etching liquid 5.

When both faces of the flexible wiring board 3 is to be etched, after the etching treatment on one face is finished and the flexible wiring board 3 is washed, the flexible wiring board 3 is turned over and the lower face is etched by providing the board to the same etching treatment as mentioned above, thereby forming the desired conductor patterns 3a.

As mentioned above, according to this embodiment, since the etching liquid 5 is linearly ejected onto the flexible wiring board 3 which is turned around the drum face 2a from the adjacent positions under the constant ejection pressure, flexure of the flexible wiring board 3 can be prevented, and the linear advancing and the constant ejection pressure of the etching liquid 5 can be ensured. As a result, the etching speed within the face of the flexible wiring board 3 can be made uniform, and the narrower pitch and the rectangular sectional shape of the conductor patterns 3a can be realized. Consequently, the high-precision conductor patterns can be formed, which can cope with the transmission of high-frequency signals.

Further, according to the present embodiment, since the plural fitted positions for the nozzle heads 4 are arranged along the drum face 2a in the outer peripheral direction of the drum 2 so that the nozzle heads 4 can be fitted to the respective fitting positions, the etching speed for the flexible wiring board 3 in the running direction B can be controlled by attaching or detaching or exchanging the nozzle heads 4.

Particularly, in the etching apparatus 1 according to an embodiment, the nozzle head 4 which is provided with the nozzle holes 40 constituted by the slit-like through-holes 41 and the nozzle head 4 which is provided with nozzle holes 40 constituted by the circular through-holes 42 are exchangeable, and by adjusting the control factors such as the width W and the length L of the slit-like through-holes 41, the number of the slit-like through-holes 41 and so on, or the control factors such as the diameter φD and the number of the provided circular through-holes 42 and so on, the conductors are etched at a uniform etching speed, even if the conductors have the difference in the thickness within the plane, while the etching speed for the flexible wiring board 3 not only in the running direction B but also in the width direction A of the flexible wiring board 3 can be controlled, and then even the conductor having different thicknesses in plane can be etched at a uniform etching speed.

Furthermore, according to this embodiment, since the etching liquid 5 inside the chamber 10 is pressurized at the constant pressure, the etching liquid 5 can be ejected at the uniform pressure, to thereby apply the uniform pressure upon the flexible wiring board 3.

In addition, according to this embodiment, since the flexible wiring board 3 is run while being turned around the drum 2, the space which is occupied by such a running line can be reduced, as compared with a case of the straight running line. Consequently, the apparatus itself can be miniaturized

In the following, other preferable embodiments of the etching apparatus according to the present application will be explained.

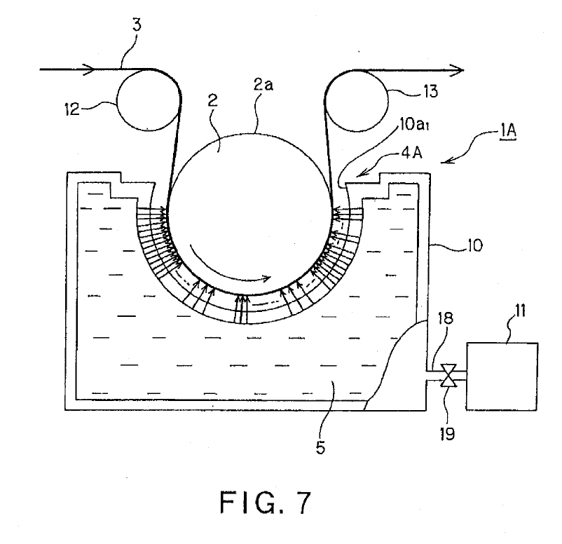

As shown in FIG. 7, according to an etching apparatus 1A shown here, an upper wall portion of a chamber and a nozzle head differ from those of the above-mentioned embodiment. In the below explanation, portions which is different from those in the above-mentioned embodiment will be mainly explained, and the identical constituent elements are given with the same reference numerals, and their detailed explanation will be omitted.

In this embodiment, the nozzle head 4A constitutes the upper wall portion 10a₁ of a chamber 10, and a curved concave face having the same curvature as that of the drum face 2a is continuously and integrally formed in a circumferential direction of a drum 2. Plural nozzle holes 40 are formed in the nozzle head 4A, penetrating in normal directions to the drum face 2a. Different from the nozzle holes provided in the above-mentioned embodiment, all the penetrating directions of the nozzle holes 40 are in parallel to the normal directions of the drum face 2a.

Although not shown, plural shielding plates are fitted to an inner wall face of the nozzle head 4A. The shield plate functions to control the etching speed in the running direction B of the flexible wiring plate 3 by shielding the nozzle holes 40 at a given interval over given areas in the circumferential direction of the drum 2. As to the nozzle holes, the control of the etching speed in the running direction B and the width direction A of the flexible wiring board 3 is the same as in the above-mentioned embodiment.

According to the present embodiment, since the nozzle head 4A is designed in the curved concaved face having a curvature identical with that of the drum face 2a and the penetrating directions of the nozzle holes 40 are all set identical with the normal directions to the drum faces 2a, the etching liquid can be ejected toward the conductor to be etched on the flexible wiring board 3 always from the normal direction of the face to the conductor. Consequently, the narrower pitch and the rectangular sectional shape of the conductor patterns to be formed can be realized at high precision.

The other construction, function and effects are the same as those in the above-mentioned embodiment.

Next, a further embodiment of the etching apparatus according to the present application will be explained.

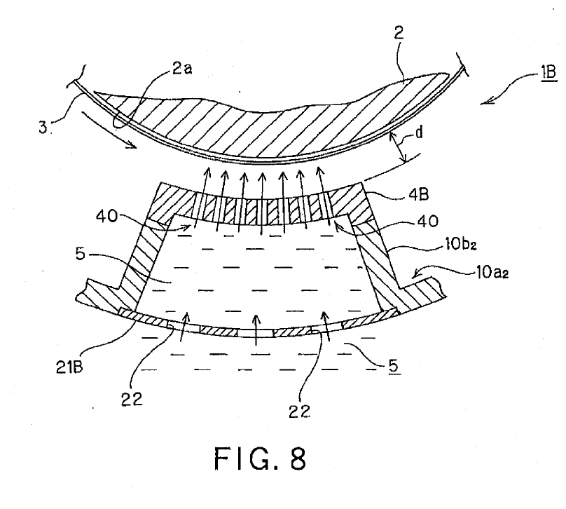

As shown in FIG. 8, in an etching apparatus 1B shown here an upper wall portion 10a₂ of a chamber 10 and a nozzle head 4B is different from the above-mentioned embodiments. In the following explanation, portions different from those in the above-mentioned embodiments will be mainly explained, and the detailed explanation will be omitted by giving the identical constituent components to the same reference numerals.

The present embodiment is identical with the above-mentioned embodiments in that the upper wall portion 10a₂ of the chamber 10 is a concave-convex shape almost along the outer circumferential direction of a drum 2, but the former differs from the latter in that an upper edge portion of a nozzle-fitting portion 10b₂ has such an open shape as contacting an curved concaved face.

The present embodiment is identical with the above-mentioned embodiments in that nozzle heads 4B are opposed to a drum face 2a at a given interval over given areas in the peripheral direction of the drum 2, but the former is identical with the latter in that the nozzle heads are formed in a curved concaved shape having a curvature equal to that of the drum face 2a.

A pressure-regulating plate 21B is attached to an inflow opening of a nozzle-fitting portion 10b₂. This pressure-regulating plate 21B is formed in a curved concaved face having a curvature equal to that of the drum face 2a.

As mentioned above, the present embodiment is more advantageous than the preceding embodiments in that the etching liquid 5 can be ejected onto the conductor to be etched on the flexible wiring board 3 always from directions of the normal lines to the face of the conductor. Also, the former is more advantageous than the latter in that the etching speed for the flexible wiring board 3 in the running direction B can be controlled by attaching, detaching or exchanging the nozzle heads 4B.

The other construction, function and effects are the same as those in the above-mentioned embodiments.

The present application can be changed or modified in various ways without being limited to the above-mentioned embodiments. For example, in the above first embodiment, the penetrating directions of the nozzle holes may be all in conformity with the normal directions to the drum face. Further, in the second embodiment, the nozzle head may be constituted as an upper wall which is detachably attached to the upper portion of the chamber.

Furthermore, it is allowed to provide plural nozzle-fitting portions in generating line directions of the drum and control the etching speed in the width direction by adjusting the fitted number of the nozzle heads in each of the above-mentioned embodiments. In addition, the etching speed and the nozzle pressure may be automatically controlled by providing a shutter mechanism with an electromagnetic valve for the nozzle holes of the nozzle head or the adjusting holes of the pressure-regulating plate.

Moreover, in each of the above-mentioned embodiments, the drum may be designed in a double structure made of an inner cylindrical portion for ejecting the etching liquid and an outer cylindrical portion for rotating and running the flexible wiring board. In this case, plural nozzle holes as mentioned above are formed in the outer peripheral face of the inner cylindrical portion, and the etching liquid stored inside is ejected through the nozzle holes by the pump pressure. On the other hand, plural passing holes are formed in the outer peripheral face of the outer cylindrical portion such that they do not overlap with the nozzle holes of the nozzle head, and the etching liquid from the inner cylindrical portion is impinged upon one face of the flexible wiring board through the passing holes, while the other face receiving the etching liquid from the nozzle head is supported. Such a double-structured drum has the advantage that both of the faces can be etched by one treatment.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An etching apparatus in which a wiring board is turned around a drum face of an outer periphery of a drum, the wiring board turned around the drum face is run along the drum face and etching is carried out by ejecting an etching liquid onto the wiring board through a nozzle head,
wherein the nozzle head is disposed at a position in a vicinity of the drum face, and the nozzle head is provided with a plurality of nozzles such that the etching liquid is linearly ejected onto the drum face.

2. The etching apparatus according to claim 1, wherein the nozzle holes include a plurality of slit-shaped through-holes extending almost in generating line of the drum face, and wherein the width W and at least a portion of the slit-shaped through-holes are set depending on an etching speed.

3. The etching apparatus according to claim 1, wherein the nozzle holes include a plurality of circular through-holes almost around normal lines to the drum face, and wherein the diameter and at least a portion of the circular through-holes are set depending on an etching speed.

4. The etching apparatus according to claim 1, further comprising,
a chamber in which the etching liquid is stored is disposed outside the drum, an upper portion of the chamber is formed with a concaved upper wall portion opposed to the drum face, and the nozzle head is attachable to a plurality of positions of the upper wall portion.

5. The etching apparatus according to claim 4, wherein the nozzle head is configured to eject the etching liquid by adjusting a pressure inside the chamber.

6. The etching apparatus according to claim 1, wherein the nozzle head is formed in a curved concaved shape having a curvature almost identical with that of the drum face.

7. A method for etching by ejecting an etching liquid onto a running wiring board, comprising:
performing etching by linearly ejecting the etching liquid onto the running wiring board on a drum face of a drum from a position in a vicinity of the drum face, while rotating the drum and turning the wiring board around the drum face of an outer periphery of the drum.

8. The etching method according to claim 7, wherein the ejecting position of the etching liquid is approached to a position spaced from the drum face by 1 mm to 10 mm.

9. The etching method according to claim 7, wherein a plurality of positions for ejecting the etching liquid are arranged along the drum face in an outer peripheral direction of the drum, a number of the positions for ejecting the etching liquid or a size of ejecting holes for the etching liquid is increased or decreased depending on an etching speed.
